(19) United States
(12) Patent Application Publication
(10) Pub. No.: US 2025/0135638 A1
(43) Pub. Date: May 1, 2025

(54) WORK ROBOT SYSTEM

(71) Applicant: FANUC CORPORATION, Yamanashi (JP)

(72) Inventor: Wataru MIYAZAKI, Yamanashi (JP)

(21) Appl. No.: 18/835,948

(22) PCT Filed: Mar. 2, 2022
(86) PCT No.: PCT/JP2022/008774

§ 371 Date: Aug. 5, 2024

(51) Int. Cl. B25J 9/16; B25J 9/00; B25J 13/08

(52) U.S. Cl. CPC B25J 9/1661; B25J 9/0093; B25J 9/1687; B25J 13/08

(57) ABSTRACT

A work robot system including a robot configured to perform an operation on a target portion of an object, and a following sensor used to detect, in sequence, at least a position of the target portion being moved, wherein a control device is configured to perform a pre-approach control that moves the component or the tool to an approach start position where the component or the tool does not interfere with a portion to be an obstacle of the object, and a following control that brings the component or the tool placed at the approach start position close to the target portion, and uses an output of the following sensor so as to follow the target portion that is being moved, and the portion to be the obstacle is a portion other than the target portion of the object.

### CROSS-REFERENCE TO RELATED APPLICATION(S)

This is a National Stage Entry into the United States Patent and Trademark Office from International Patent Application No. PCT/JP2022/008774, filed on Mar. 2, 2022, the entire content of which is incorporated herein by reference.

### FIELD OF THE INVENTION

The present disclosure relates to a work robot system.

### BACKGROUND OF THE INVENTION

In the related art, there is often a case in which a conveying device is stopped to assembly a component to an object which is being conveyed by a conveying device. Especially, it is necessary to stop objects being conveyed by the conveying device to assembly the component to a large object such as a vehicle body and the like. This may leads to a decrease in work efficiency.

In contrast, there is a known work robot system that includes a conveying device for conveying objects and a robot, and the work robot system assemblies the component to the object in a state where the object is being conveyed by the conveying device. For example, see Japanese Unexamined Patent Application, Publication No. 2019-136808. In this work robot system, when the object is conveyed to a predetermined position by the conveying device, the robot brings the component close to a target portion of the object, and the robot causes the component to follow the target portion when a distance between the component and the object becomes smaller than a predetermined distance.

Also, there is a known work robot system that includes a conveying device for conveying an object and a robot, and when the object is conveyed to a predetermined position by the conveying device, the work robot system stops the object being conveyed by the conveying device, and the robot performs a work on the object which is being stopped. For example, see Japanese Unexamined Patent Application, Publication No. 2003-330511.

### SUMMARY

A work robot system according to a first aspect of the present disclosure is a following robot including: a robot configured to perform a predetermined operation on a target portion of an object being moved by an object moving device; a control device used for controlling the robot; and a following sensor used to detect, in sequence, at least a position of the target portion being moved by the object moving device when a component or a tool supported by the robot is caused to follow the target portion, wherein the control device is configured to perform: a pre-approach control that controls the robot to move the component or the tool to an approach start position where the component or the tool does not interfere with a portion to be an obstacle of the object that is being moved by the object moving device; and a following control that controls the robot to bring the component or the tool placed at the approach start position close to the target portion, and uses an output of the following sensor to control the robot so that the component or the tool is caused to follow the target portion that is being moved by the object moving device, and the portion to be the obstacle is a portion other than the target portion of the object.

A robot according to a second aspect of the present disclosure including: an arm configured to perform a predetermined work on a target portion of an object being moved by an object moving device; a control device used for controlling the arm; and a following sensor capable of detecting, in sequence, at least a position of the target portion being moved by the object moving device when a component or a tool supported by the arm is caused to follow the target portion, wherein the control device is configured to perform: an pre-approach control that controls the arm to move the component or the tool to an approach start position where the component or the tool does not interfere with a portion to be an obstacle of the object being moved by the object moving device; and a following control which controls the arm to bring the component or the tool placed at the approach start position close to the target portion, and uses an output of the following sensor to control the arm so as to cause the component or the tool to follow the target portion being moved by the object moving device, and the portion to be the obstacle is a portion other than the target portion of the object.

### BRIEF DESCRIPTION OF DRAWINGS

FIG. 1 is a schematic side view of a work robot system according to a first embodiment of the present disclosure.

FIG. 2 is a schematic plan view of the work robot system of the first embodiment.

FIG. 3 is an example of image data acquired by a sensor of the work robot system of the present embodiment.

FIG. 4 is a block diagram of a control device of the work robot system according to the first embodiment.

FIG. 5 is a flowchart showing an example of processing performed by the control device of the work robot system according to the first embodiment.

FIG. 6 is a schematic plan view of a work robot system according to a second embodiment of the present disclosure.

### DESCRIPTION OF EMBODIMENT(S)

There is a work robot system which performs work on the object when the object is being stopped. In another work robot system, there may be a case in which orientation of the object being conveyed by the conveying device is different from the orientation at the time of teaching the robot. Also, the robot is taught, operated, and the like in various situations, and it is often the case that the robot and the conveying device are not in a fully cooperation manner with each other. For example, if the robot stops during a test operation while the robot is bringing the component close to the target portion, the component may come into contact with the object being conveyed by the conveying device. The robot is taught, operated, and the like in various situations and it is preferable to avoid the component or a tool provided at a distal end portion of the robot and the object from coming into contact with each other as much as possible.

A work robot system according to a first embodiment of the present disclosure will be described below with reference to the drawings.

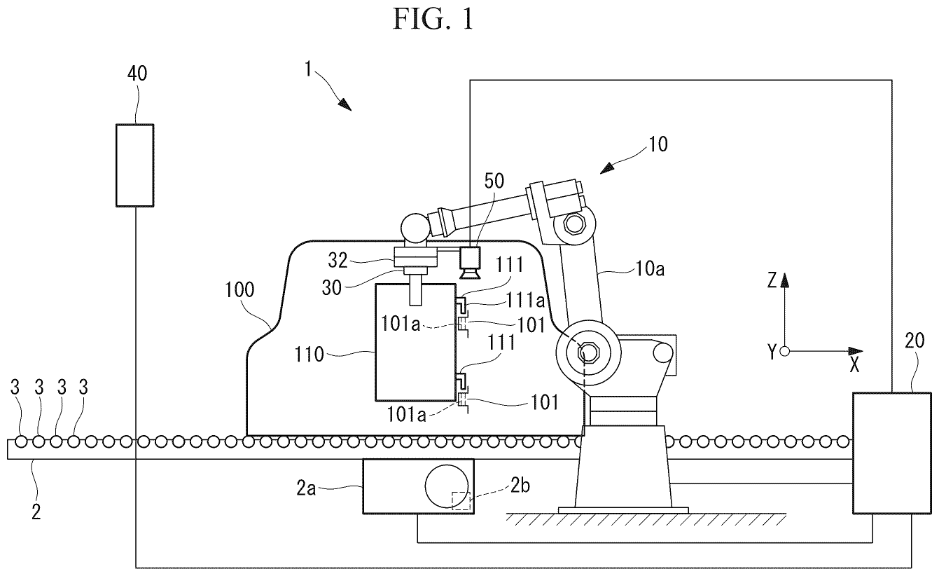

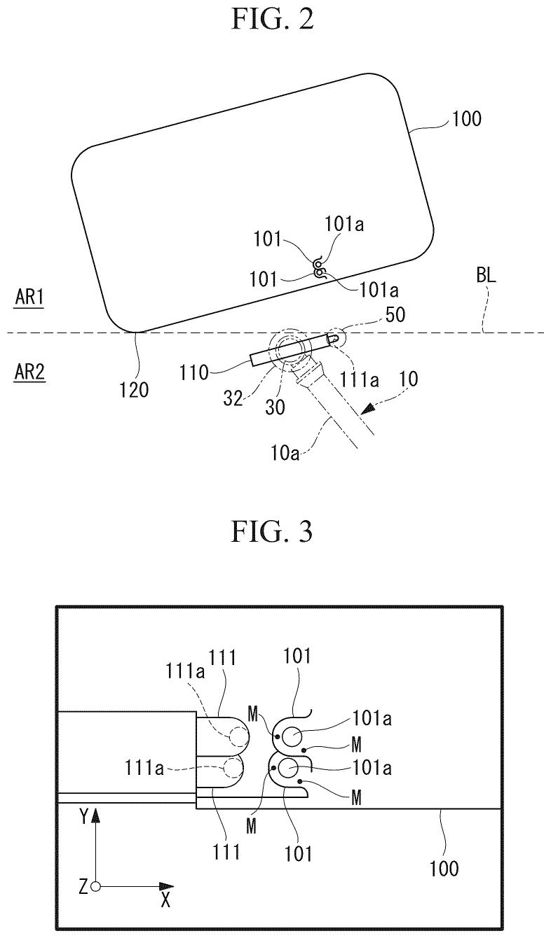

As shown in FIGS. 1 and 2, the work robot system of this embodiment includes a conveying device (an object moving device) 2 that conveys an object 100 which is a work target, a robot 10 that performs a predetermined work on a target portion 101 of the object 100 conveyed by the conveying device 2, a control device 20 that controls the robot 10, and a detection device 40.

The detection device 40 acquires data that can identify at least a position of the target portion 101 of the object 100 conveyed by the conveying device 2. The detection device 40 may acquire data that can identify the position and orientation of the target portion 101. In this embodiment, the target portion 101 has a plurality of holes 101a. A function of the detection device 40 may be performed by a following sensor 50 which will be described below.

It is possible to employ any device having such a function as the detection device 40. For example, the detection device 40 can be a two-dimensional camera, a three-dimensional camera, a three-dimensional distance sensor, a sensor that irradiates a line beam to the work target to measure its shape, a photoelectric sensor, and the like. The detection device 40 in this embodiment is a two-dimensional camera provided along a conveyance route of the conveying device 2. The detection device 40 acquires image data of the target portion 101 in a state where the target portion 101 is positioned in a predetermined area of an angle of view, and the detection device 40 sends the image data to the control device 20 as an output. The detection device 40 may be a camera or a sensor that faces a downward direction or a camera or a sensor that faces a diagonally downward direction, and the like.

The image data is data that can identify a position of at least one of the plurality of target portions 101. There is a case where the control device 20 identifies the position of the target portion 101 based on a position, shape, and the like of a feature part of the object in the image data. Also, the control device 20 can identify the orientation of the target portion 101 based on a position relation of the plurality of the target portions 101 in the image data. The detection device 20 can identify the orientation of the target portion 101 based on the position, shape, and the like of the feature part in the image data. The feature part may be an element with a feature such as a mark M shown in FIG. 3, a corner portion of the object 100, and the like.

Although the object 100 is not limited to a particular type, the object 100 of the present embodiment is a body of a vehicle as an example. The conveying device 2 is to move the object 100 in one direction by driving a motor 2a, the conveying device 2 in this embodiment moves the object 100 toward the right side in FIG. 1. The motor 2a includes an operating-position detection device 2b, and the operating-position detection device 2b detects, in sequence, a rotation position and a rotation amount of an output shaft of the motor 2a. An example of the operating-position detection device 2b is an encoder. The detection value detected by the operating-position detection device 2b is sent to the control device 20. The conveying device 2 may include another structure for moving the object 100, such as a belt and the like, for example.

The target portion 101 of the object 100 is a portion on which the robot 10 performs the predetermined work. In this embodiment, the predetermined work refers to a work in which the robot 10 lifts a component 110 by using a hand 30 of the robot 10, and the robot 10 attaches an attaching portion 111 of the component 110 to the target portion 101. By doing so, for example, a plurality of shafts 111a extending downwardly from the attaching portion 111 of the component 110 are fitted into a plurality of holes 101a provided in the target portions 101 of the object 100. In this embodiment, the arm 10a of the robot 10 attaches the attaching portion 111 of the component 110 to the target portion 101 in the state in which the object 100 is being moved in one direction by the conveying device 2.

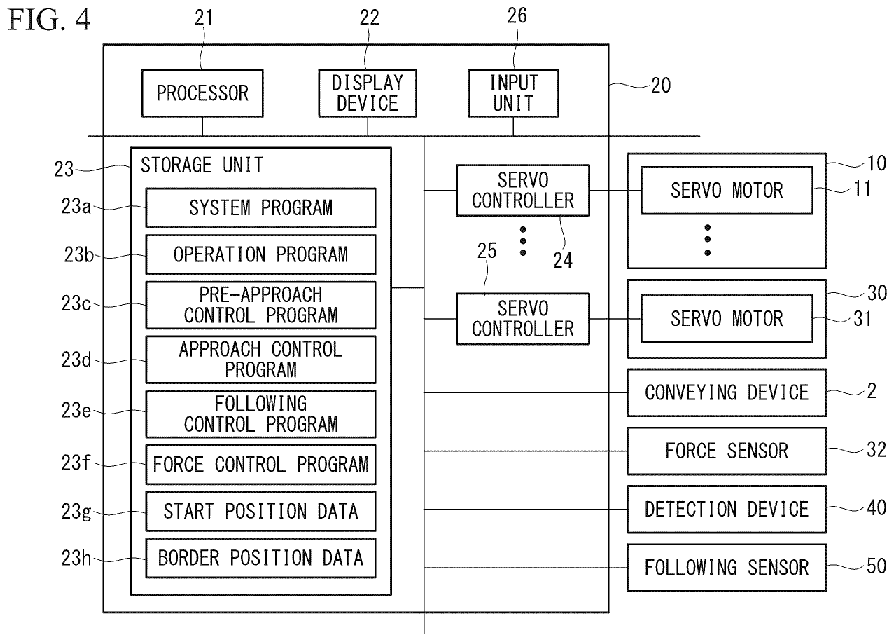

Although the robot 10 is not limited to a particular type, it is possible to use a six-axis articulated robot. The arm 10a of the robot 10 of this embodiment includes a plurality of servo motors 11 that respectively drive a plurality of movable portions (see FIG. 4). Each of the servo motors 11 has an operating-position detection device for detecting its operating position, and an example of the operating-position detection device is an encoder. The detection value detected by the operating-position detection device is sent to the control device 20.

The hand 30 for moving the component 110 is attached to a distal end portion of the robot 10.

In one example, the hand 30 includes a servo motor 31 that drives the claws (see FIG. 4). The servo motor 31 has an operating-position detection device for detecting its operating position, and an example of the operating-position detection device is an encoder. The detection value detected by the operating-position detection device is sent to the control device 20. As the individual servo motors 11 and 31, various types of servo motors, such as rotary motors and linear motors, can be employed.

A force sensor 32 is attached to a distal end portion of the robot 10. The force sensor 32 detects forces for example, in an X-axis direction, a Y-axis direction, and a Z-axis direction, which are shown in FIGS. 1 and 3. The force sensor 32 detects forces around the X axis, around the Y axis, and around the Z axis as well. It is satisfactory so long as the force sensor 32 is capable of detecting the direction of the force and the magnitude of the force acting on the hand 30 or the component 110 gripped by the hand 30. Accordingly, although the force sensor 32 is provided between the robot 10 and the hand 30 in this embodiment, the force sensor 32 may be provided inside the hand 30, a base end portion of the arm 10a, another portion of the arm 10a, a base of the robot 10, and the like.

The following sensor 50 is attached to the distal end portion of the robot 10. In one example, the following sensor 50 is attached to a wrist flange of the arm 10a as well as the hand 30. The following sensor 50 is a two-dimensional camera, a three-dimensional camera, a three-dimensional distance sensor, and the like. The following sensor 50 in this embodiment is a two-dimensional camera, and the following sensor 50 is a sensor acquires, in sequence, image data of the target portion 101, as shown in FIG. 3, in a state where the target portion 101 is in a predetermined area of the angle of view. The following sensor 50 sends, in sequence, the image data (output) to the control device 20. The image data is data that can identify at least the position of the target portion 101 conveyed by the conveying device 2. The following sensor 50 may acquire data that can identify the position and the orientation of the target portion 101.

The image data is data that can identify the position of at least one of the plurality of the target portions 101. There may be a case where the control device 20 identifies the position of the target portion 101 based on a position, shape, and the like of the feature part of the object in the image data. Also, the control device 20 can identify the orientation of the target portion 101 based on a positon relation of the plurality of the target portions 101 in the image data. The control device 20 can identify the orientation of the target portion 101 based on the position, the shape, and the like of the feature part in the image data. The feature part may be an element with a feature such as the mark M shown in FIG. 3, the corner portion of the object 100, and the like.

The position and orientation of a coordinate system of the following sensor 50 and the position and orientation of a coordinate system of the robot 10 are associated with each other in advance in the control device 20. For example, the coordinate system of the following sensor 50 is set to be a reference coordinate system of the robot 10 that operates according to a operation program 23b. It is possible to associate a coordinate system that has a tool center point (TCP) of the hand 30 as its origin with a coordinate system having a reference position of the component 110 as its origin, and the like.

As shown in FIG. 4, the control device 20 includes a processor 21 having a processor element or plurality of processor elements such as a CPU, a microcomputer, and the like, a display device 22, a storage unit 23 having a non-volatile storage, a ROM, a RAM, and the like, a plurality of servo controllers 24 that respectively correspond to the servo motors 11 of the robot 10, a servo controller 25 that corresponds to the servo motor 31 of the hand 30, and an input unit 26 that is connected to the control device 20. In one example, the input unit 26 is an input device such as an operation panel and the like that can be carried by a user. There is a case in which the input unit 26 wirelessly communicates with the control device 20, and the input unit 26 in another example is a tablet computer. In such a case where the input unit 26 is the tablet computer, input is made by using a touch screen function. There is also a case in which the operation panel or the tablet computer has the display device 22.

The storage unit 23 stores a system program 23a, and the basic functions of the control device 20 are performed by the system program 23a. In addition, the storage unit 23 stores a operation program 23b. The storage unit 23 additionally stores a pre-approach control program 23c, an approach control program 23d, a following control program 23c, and a force control program 23d.

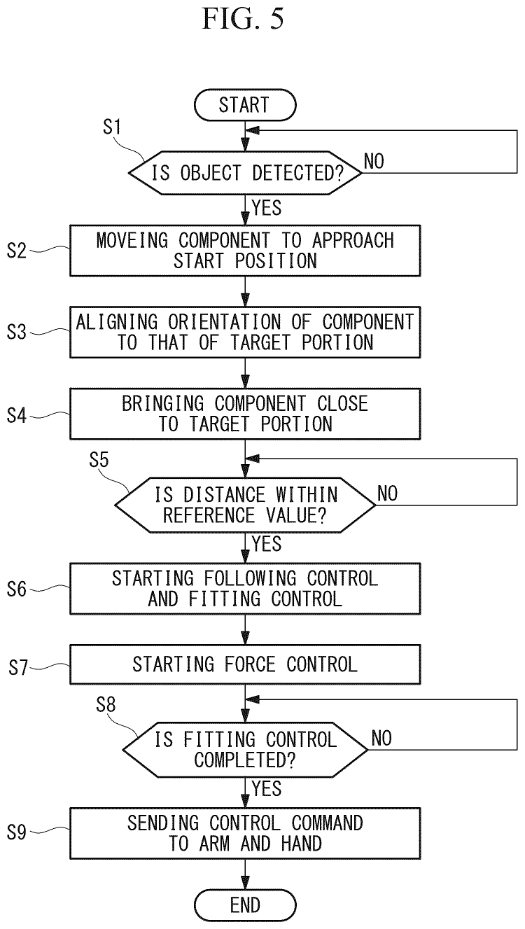

The control device 20 sends, on the basis of the aforementioned programs, control commands for performing the predetermined work on the object 100 to the respective servo controllers 24 and 25. Accordingly, the robot 10 and the hand 30 perform the predetermined work on the object 100. The operation of the control device 20 will be described with reference to the flowchart in FIG. 5.

First, when the detection device 40 or the following sensor 50 detects the object 100 (step S1), the control device 20 starts to send control commands based on the pre-approach control program 23c to the arm 10a and the hand 30 (step S2). By this, the arm 10a moves the hand 30 placed at a standby position to a position where the component 110 is placed so that the hand 30 can grip the component 110, and the arm 10a moves the component 10 to an approach start position which is shown in FIG. 2. As shown in FIG. 2, the approach start position is a position located at a robot 10 side than a border line BL.

Here, positions and orientations of the objects 100 on the conveying device 2 are different from each other. This difference occurs at the time of placing the objects 100 on the conveying device 100. Also, this difference occurs when the objects 100 on the conveying device 2 are slightly moved in unintended direction by oscillation and the like. As shown in FIG. 2, when the object 100 is placed on the conveying device 2 in a state where the object 100 is rotated around a vertical axis line, at a side of the object 100 which is nearer to the robot 10 than the other side in the Y direction, one end portion 120 in the X direction of the object 10 is closer to the robot 10 than the target portion 101 in the Y direction.

The one end portion 120 is a portion to be an obstacle. In FIG. 2, the rotation of the object 100 is shown in an exaggerated manner. When the length of the object 100 is around 5 m, for example, and when a position of the object 100 in the rotation direction around the axis line varies in a range of about 2 degrees, the position of the one end portion 120 will be different by 10 cm in the Y direction, and in some cases, the difference in position will be more than 20 cm. In addition to this difference in position, when the loading position is different in the Y direction, the difference in position of the one end portion 120 in the Y direction will be further increased.

In one example, a start position data 23g that is coordinate values of the component 110 at an approach start position, a coordinate value of the hand 30, or coordinate values of the distal end portion of the arm 10a is stored in a non-volatile storage, a RAM, and the like of the storage unit 23 of the control device 20 (see, FIG. 4). The start position data 23g is configured so as to prevent the component 110 from interfering with the one end portion 120 being conveyed by means of the conveying device 2. That is, as shown in FIG. 2, when this setting is applied and the component 110 is placed at the approach start position corresponding to the start position data 23g, the component 110 does not interfere with the one end portion 120 even though the one end portion 120 is being conveyed by means of the conveying device 2 until it passes a position in front of the component 110. The interference in this embodiment refers to an interference that occurs when the one end portion 120 is passing the position in front of the component 110.

In another example, at least one of position information of a border line BL, information of an area AR1 where the interference could occur, and information of an area AR2 where the interference does not occur are stored as a border position data 23h in a non-volatile storage, a RAM, and the like of the storage unit 23 of the control device 20 (see, FIG. 4). As can be seen from FIG. 2, the border line BL is a line that divides the area AR1 where the interference could occur and the area AR2 where the interference does not occur.

With the start position data 23g or the border position data 23h, the component 110 is placed at the approach start position so as to prevent the component 110 from coming into contact with the object 100.

In this embodiment, it is sufficient to have at least one of the settings of the start position data 23g and the border position data 23h. In one example, the start position data 23g and the border position data 23h are stored in the storage unit 23 according to the input made to the input unit 26 by the user. In another example, the control device 20 uses the image data of the detection device 40 or the following sensor 50 to detect or calculate a route of the one end portion 120 which is being conveyed by the conveying device 2. In one example, the route corresponds to the border line BL. And, the control device 20 sets the start position data 23g and the border position data 23h based on the detection result or the calculation result, and the set start position data 23g and border position data 23h will be stored in the storage unit 23. The control device 20 may update the start position data 23g and the border position data 23h every time the subsequent object 100 is conveyed.

The control device 20 adjusts the orientation of the component 110 at the approach start position or the orientation of the component 110 that is moving to the approach start position to be aligned with the orientation of the target portion 101 according to the pre-approach control program 23c (Step S3). In one example, the control device 20 adjusts the orientation of the component 110 while the component 110 is moving to the approach start position, or when the component 110 reaches the approach start position. For example, the control device 20 uses the image data of the following sensor 50 to detect the orientation of the target portion 101, and adjusts the orientation of the component 110 to be aligned with the detected orientation.

There is a case in which a moving route of the object 100 on the conveying device 2 is not a straight line. Also, the orientation of the object 100 gradually changes on the conveying device 2 due to oscillations and the like. In these cases, the control device 20 may cause the orientation of the component 110 at the approach start position or the component 110 moving to the approach start position to be aligned with the orientation of the target portion 101 according to the pre-approach control program 23c in step S3.

For the following control, the control device 20 provides visual feedback using the image data that is acquired in sequence by the following sensor 50, for example. In another example, the control device 20 uses data that is acquired in sequence by another camera, or another sensor, and the like. Preferably, the start position data 23g is set so as to prevent the component 110 from coming into contact with the object 100 even when the orientation of the target portion 101, the component 110, and the hand (tool) 30 are changed. The following sensor 50, the other camera, and the other sensor may be a three-dimensional camera or a three-dimensional distance sensor depending on a type and a shape of the target portion 101. With the above configuration, the component 110 is smoothly and certainly attached to the target portion 101 while preventing the component 110 from coming into contact with the object 100 at the approach start position.

The control device 20 may change the start position data 23g or the border position data 23h for an object 100 on which the robot 10 will perform the work next. For example, when the object 100 on which the work will be performed next is conveyed, the control device 20 uses the image data to detect the position of the one end portion 120 of the object 100, and uses the position or uses the position and the moving route data of the conveying device 2 to change the start position data 23g or the border position data 23h. Or, when the object 100 on which the operation will be performed next is conveyed, the control device 20 uses the image data to detect the position and the orientation of the object 100 or the one end portion 120, and uses the position and the orientation or the orientation and the moving route data to change the start position data 23g or the border position data 23h. The change may be made before proceeding with step S2, for example.

Changing the start position data 23g or the border position data 23h in this manner will prevent a distance between the component 110 and the target portion 101 at the approach start position from being unnecessarily far away. This is advantageous for accurately aligning the orientation of the component 110 with the target portion 101 as described above.

It is also possible to apply the above described configuration to a work robot system in which the robot 10 performs other operations such as processing, assembly, inspection, observation, and the like. The object 100 can be any object as long as it is movable by some sort of a conveying means, and it is also possible to use any robot other than the robot 10 as an object moving device. When the object 100 is a vehicle body or a frame of a vehicle, the vehicle body or the frame may be conveyed by an engine, a motor, a wheel, and the like provided in the vehicle or the frame. In this case, the engine, the motor, the wheel, and the like operate as the object moving device. An AGV (Auto Guided Vehicle) and the like that is as the object moving device may convey the object 100. Also, in these cases, the control device 20 may receive the moving route data from the control device of the other robot, the vehicle, the AGV, a sensor provided on them, and the like. Or, the control device 20 may calculate the moving route data by using the image data that is acquired in sequence.

Next, the control device 20 sends control commands to the arm 10a according to the approach control program 23d (step S4). By this, the arm 10a brings the component 110 close to the target portion 101. Preferably, before proceeding with step S4, the control device 20 determines whether or not the target portion 101 is placed at a position allowing the following control of step S6 according to the output of the following sensor 50, the other camera, the other sensor, and the like. And, the control device 20 brings the component 110 close to the target portion 101 if the target portion 101 is placed at the position where the following control is possible.

In step S4, the control device 20 may move the component 110 only by a predetermined distance toward the target portion side 101 by means of the arm 10a. In step S4, the control device 20 may use the data of the following sensor 50, the detection device 40, the other camera, or the other sensor to bring the component 110 close to the target portion 101 by means of the arm 10a. At this time, the control device 20 may cause the orientation of the component 110, which is moving close to the target portion 101, to follow the orientation of the target portion 101 by the visual feedback using the data. In this embodiment, in such a case where the other camera or the other sensor is placed to observe the target portion 101 and the component 110 from the above, the control in step S4 will be more accurate.

Controlling the arm 10a of step S4 allows the component 110 to be in the position and the orientation which can fit into the target portion 101. By this, when the target portion 101 starts to exist in a predetermined area of an angle of view of the following sensor 50, and a distance between an attachment portion 111 of the component 110 and the target portion 101 is within a reference value (step S5), the control device 20 starts to perform following control which causes the component 110 to follow the target portion 101 according to the following control program 23e, and starts to perform a fitting control for fitting the attachment portion 111 into the target portion 101 according to the operation program 23b (step S6).

In one example, to perform the following control according to the following control program 23e, the control device 20 performs the visual feedback using the image data which is acquired in sequence by the following sensor 50. It is possible to use a known visual feedback sensor. In this embodiment, it is possible to use the following two control methods as the visual feedback control, for example. Also, in the two control methods, the following sensor 50 detects at least the position of the target portion 101, and the processor 21 makes the distal end portion of the robot 10 follow the target portion 101 based on the detected position.

The first control method is a control in which the feature part of the object 100 is placed at a predetermined position in the angle of view of the following sensor 50 at any time so that the distal end portion of the robot 10 follows the target portion 101. The second one is a control that causes the distal end portion of the robot 10 to follow the target portion 101 by detecting the position of the feature part of the object 100 in the coordinate system of the robot 10 (a position with respect to the robot 10) and adjusting the operation program 23b by using the detected feature part.

In the first control method, the control device 20 detects the feature part in the image data that is acquired in sequence by the following sensor 50. The feature part is the overall shape of the target portion 101, a hole 101a on the target portion 101, the mark M (FIG. 3) provided on the target portion 101, and the like.

And, the control device 20 uses the image data acquired in sequence by the following sensor 50 to send control commands, to the servo controllers 24, for placing the detected feature part to be at a predetermined position in the image data so as to be within a reference shape and size at any time. In this case, the following sensor 50 is used for detecting, in sequence, the position and the orientation of the target portion 101. In another example, the control device 20 uses the image data that is acquired in sequence by the following sensor 50 to send control commands, to the servo controllers 24, for placing the detected feature part at a predetermined position in the image data at any time. When the following sensor 50 is a three-dimensional camera, a three-dimensional distance sensor, and the like, the control device 20 sends control commands, to the servo controller 24, for placing the feature part so as to be in reference orientation at a predetermined position in the three-dimensional image data.

At this time, it is preferable that the control device 20 uses a feature part that can be seen from the following sensor 50 when performing the fitting work, not a feature part that cannot be seen from the following sensor 50 when performing the fitting work. Or, the control device 20 can change the feature part to be used for the following control to another one when the feature part to be used for the following control becomes unable to be seen from the following sensor 50.

In the second control, the control device 20 uses the image data which is acquired in sequence by the following sensor 50 to detect an actual position of the feature part of the object 100 with respect to the coordinate system which is possessed by the robot 10. And, the processor 21 adjusts a teaching point of the operation program 23b on the basis of a difference between a position of the feature part in the operation program 23b and an actual position of the feature part.

In a state in which the control is being performed in the stated manner, the control device 20 starts to perform force control according to the force control program 23d (step S7). It is possible to employ well-known force control as the force control. In this embodiment, the arm 10a moves the component 110 in a direction for escaping from the force detected by the force sensor 32. The control device 20 determines the movement amount of the component 110 in accordance with the detection value of the force sensor 32.

For example, in a situation in which the shaft 111a of the component 110 gripped by the hand 30 starts to be fitted into the hole 101a of the object 100 by the operation program 23b, when the force sensor 32 detects force in a direction opposite from the conveying direction of the conveying device 2, the control device 20 causes the component 110 to slightly move in the direction opposite from the conveying direction while performing the following control. Or, when the force sensor 32 detects a force greater than a reference value, the control device 20 executes abnormality response operation.

On the other hand, the control unit 20 determines whether or not the fitting work has been completed (step S8) and sends a predetermined control command to the arm 10a and the hand 30 in the case in which the fitting work has been completed (step S9). Accordingly, the hand 30 moves away from the component 110, and the arm 10a moves the hand 30 to a standby position or a location where the subsequent components 110 are stocked.

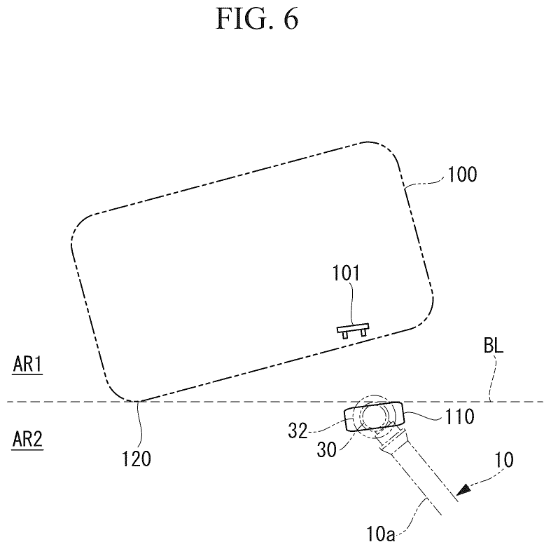

A work robot system according to a second embodiment will be described by referring to FIG. 6. In the second embodiment, the object 100 gripped by the hand 30 in the first embodiment is a tire, and the target portion 101 is a hub of a front wheel. In the second embodiment, a component that is the same or corresponding to the first embodiment is represented by the same reference numeral and its description will be omitted.

Step S1, step S2, step S3 of the first embodiment will also be performed in the second embodiment.

Here, orientation of the hub for the front wheel changes easily depending on a position of a stealing wheel of a vehicle, the orientation of the hubs on the conveying device 2 is rarely be fixed perfectly. In step S3, the control device 20 uses the image data of the following sensor 50 to detect the orientation of the target portion 101 and adjusts the orientation of the component 110 to be aligned with the detected orientation. For that reason, the component 110 can be attached to the target portion 101 smoothly and certainly.

Also, there may be case in which the orientation of the hub is slightly changed due to oscillation of the object 100 on the conveying device 2. In this case, similar to the first embodiment, the control device 20 causes the orientation of the component 110 at the approach start position or the orientation of the component 110 moving toward the approach start position to follow the orientation of the target portion 101 in step S3. This is advantageous for smoothly and certainly attaching the component 110 to the target portion 101.

Preferably, in the first and the second embodiments, the start position data 23g is set so that the component 110 does not enter the area AR where the interference could occur after the orientation of the component 110 at the approach start position is adjusted or the orientation of the component 110 at the approach start position is caused to follow the orientation of the target portion 101.

Next, similar to the first embodiment, steps S4 to S9 will also be executed in the second embodiment.

In addition, a tool may be supported at the distal end portion of the robot 10, and the robot 10 may perform a predetermined work on the object 100 being conveyed by the conveying device 2 by using the tool. In this case, the tool is a drill, a milling cutter, a drill tap, a deburring tool, another tool, a welding tool, a painting tool, a seal application tool, and the like. In this case also, the tool is placed at the approach start position in step S2, and the orientation of the tool is adjusted to be aligned with the orientation of the target portion 101 in step S3. Also, as a result of the tool that is brought close to the target portion 101 in step S4, and a distance that is between the tool and the target portion 101 becomes smaller than a predetermined value in step S5, the arm 10a uses the tool to perform a work such as processing, welding, painting, sealing, and the like on the target portion 101 in step S6.

As has been described above, in the above described embodiments, the control device 20 controls the arm 10a so as to bring the component 110 or the tool placed at the approach start position close to the target portion 101. Also, the control device 20 controls the arm 10a using the output of the following sensor 50 so that the component 110 or the tool follows the target portion 101 being conveyed on the object moving device. Before bringing the component 110 or the machining tool close to the target portion 101, the control device 20 controls the arm 10a to move the component 110 or the tool to the approach start position at which the component 110 or the tool cannot interfere with the one end portion 120 of the object 100 being conveyed on the conveying device 2. Here, the one end portion 120 is a portion other than the target portion 101 of the object 100, and also, the one end portion 120 is a portion to be an obstacle that may be interfered with the component 110 or the tool.

There are many robot systems in which the robot 10 and the object moving device are not fully in a cooperation manner with each other. Here, there may also be a case in which the target portion 101 moves to a lower side than the work area of the arm 10a in a state where the arm 10a places the component 110 or the tool at the approach start position during teaching operation of the robot 10, during test operation of the robot 10 after teaching, during operation of the robot 10 in an unintended situation, and the like. Similarly, there may also be a case where the target portion 101 moves to the lower side than the work area of the arm 10a in a state where the arm 10a is moving the component 110 or the tool to the approach start position. In these cases, the component 110 or the tool does not interfere with the one end portion 120 of the object 100, and the like. The robot 10 is taught, operated, and the like in different situations, however, the above described configuration is advantageous for reducing or eliminating the contact of the component 110 or the tool provided at the distal end portion of the robot 10 with the object 100.

In each of the above described embodiments, the approach start position will be changed by using at least one of the position data and the orientation data of the object 100 being conveyed by the object moving device and the moving route data of the object 100. Therefore, this configuration prevents the distance between the component 110 and the target portion 101 at the approach start position from being unnecessary far away. Moreover, it is also possible to align the orientation of the component 110 and the target portion 101 accurately.

For example, there may be a case where the moving route of the object 100 conveyed by the object moving device is not a straight line. Or, there may be a case where the orientation of the object 100 on the object moving device gradually changes due to oscillation and the like. In each of the embodiments, the orientation of the component 110 or the tool is made follow the orientation of the target portion 101 by the pre-approach control. This configuration achieves smooth and certain attachment of the component 110 to the target portion 101 while preventing the component 110 from coming into contact with the object 100 at the approach start position.

Furthermore, the control device 20 may send the data to the display device 22, the input unit 26 with a display device, a computer of a user that has a display device, and the like, and with these display devices, an area display may be performed to indicate the area AR1 in which the interference could occur, or the area AR2 in which the interference does not occur. When the area display is indicated on the display device of the computer of the user, the computer plays a function as a part of the robot system. Preferably, a display enables to identify the position of the component 110 or the tool, a display enables to identify the position of the distal end portion of the arm 10a, and the like are indicated together with the area display. Normally, the control device 20 that controls the arm 10a recognizes the position of the component 110 or the tool and the position of the distal end portion of the arm 10a.

This configuration is advantageous for grasping the operation of the arm 10a according to the pre-approach control during the robot teaching operation of the robot 10, during a test operation of the robot 10 after the teaching operation, during a normal operation of the robot 10, and the like.

Also, the control device 20 may indicate the approach start position on the display device together with the area display. This configuration is advantageous for users to know whether or not the setting is appropriate intuitively and certainly.

Also, the following sensor 50 may be attached at a distal end portion of another six-axis articulated robot instead of attaching it to the distal end portion of the robot 10. In this case, the position and the orientation in the coordinate system of the following sensor 50, the position and the orientation in the coordinate system of the robot 10, and a position and orientation in the coordinate system of the other articulated robot are associated with each other. And, the coordinate system of the following sensor 50 is set to be a reference coordinate system of the other articulated robot and the robot 10. When the robot 10 is controlled and the like according to the control data of the other articulated robot, the visual feedback using the output of the following sensor 50 is possible.

Moreover, the following sensor 50 may be fixed at an upper side of the work area of the robot 10, and the following sensor 50 may be supported at the upper side of the work area of the robot 10 so as to be movable in a X direction, a Y direction, a Z direction, and the like. For example, the following sensor 50 is supported movably in the X direction and the Y direction by using a X direction linear motion mechanism movable in the X direction, a Y direction linear motion mechanism that is supported by the X direction liner motion mechanism and movable in the Y direction, and a plurality of motors. In these cases also, the visual feedback using the output of the following sensor 50 is possible.

1. A work robot system comprising:
a robot configured to perform a predetermined operation on a target portion of an object being moved by an object moving device;
a control device used for controlling the robot; and
a following sensor used to detect, in sequence, at least a position of the target portion being moved by the object moving device when a component or a tool supported by the robot is caused to follow the target portion, wherein
the control device is configured to perform:
a pre-approach control that controls the robot to move the component or the tool to an approach start position where the component or the tool does not interfere with a portion to be an obstacle of the object that is being moved by the object moving device; and
a following control that controls the robot to bring the component or the tool placed at the approach start position close to the target portion, and uses an output of the following sensor to control the robot so that the component or the tool is caused to follow the target portion that is being moved by the object moving device, and
the portion to be the obstacle is a portion other than the target portion of the object.

2. The work robot system according to claim 1, wherein the control device uses data of at least one of a position and an orientation of the object being moved by the object moving device and data of a moving route of the object to change the approach start position.

3. The work robot system according to claim 1, wherein the control device makes the orientation of the component or the tool to follow the orientation of the target portion.

4. The work robot system according to claim 1 further comprising a display device configured to perform an area display where interference occurs with the portion to be the obstacle being moved by the object moving device or an area where the interference does not occur.

5. The work robot system according to claim 4, wherein the display device displays the approach start position together with the area display.

6. A robot comprising:
an arm configured to perform a predetermined work on a target portion of an object being moved by an object moving device;
a control device used for controlling the arm; and
a following sensor capable of detecting, in sequence, at least a position of the target portion being moved by the object moving device when a component or a tool supported by the arm is caused to follow the target portion, wherein
the control device is configured to perform:
an pre-approach control that controls the arm to move the component or the tool to an approach start position where the component or the tool does not interfere with a portion to be an obstacle of the object being moved by the object moving device; and
a following control which controls the arm to bring the component or the tool placed at the approach start position close to the target portion, and uses an output of the following sensor to control the arm so as to cause the component or the tool to follow the target portion being moved by the object moving device, and
the portion to be the obstacle is a portion other than the target portion of the object.
